(19) United States
(12) Patent Application Publication
(10) Pub. No.: US 2011/0088972 A1
(43) Pub. Date: Apr. 21, 2011

(54) Elevator work deck

(76) Inventors: Kirk Bradley Gregus, Burnaby (CA); Sean Scott, Burnaby (CA)

(21) Appl. No.: 12/908,859

(22) Filed: Oct. 20, 2010

Related U.S. Application Data
(60) Provisional application No. 61/253,402, filed on Oct. 20, 2009.

(51) Int. Cl. E04G 5/04; E04G 5/14; E04G 3/24; B23P 17/04

(52) U.S. Cl. 182/113; 182/222; 182/152; 29/525.01

(57) ABSTRACT

An elevator work deck for use during elevator construction including a first support having a top surface and a bottom surface, and a second support having a top surface and a bottom surface. There are means for positioning the first support and the second support in abutting edge to edge relation so that the top surface of the first support and the top surface of the second support define a planar horizontal working surface when assembled in an operative position. Fastener receivers are positioned on the bottom surface of each of the first support and the second support. There are clamping fastener assemblies engaging the fastener receivers to clamp the first support and the second support to elevator car sling structural beams.

### FIELD

There is described a reusable and foldable elevator work deck for use during elevator service and construction.

### BACKGROUND

During elevator construction, the structural cage used to support a future elevator cab (also called a permanent car sling) is built at the lowest level. Workers must work on top of the car sling as it is raised to install the requisite elevator components, such as the rails. Temporary, ad hoc decks are built on top of the car sling and are subsequently torn out by workers and discarded after use.

### SUMMARY

In one aspect, there is provided an elevator work deck including a first support having a top surface and a bottom surface, and a second support having a top surface and a bottom surface. There are means for positioning the first support and the second support in abutting edge to edge relation so that the top surface of the first support and the top surface of the second support define a planar horizontal working surface when assembled in an operative position. Fastener receivers are positioned on the bottom surface of each of the first support and the second support. There are clamping fastener assemblies engaging the fastener receivers to clamp the first support and the second support to elevator car sling structural beams.

Preferably, a channel member may be secured to the bottom surface of each of the first support and the second support, the channel member having retention lips extending parallel to an axis of the channel member. The fastener receivers are movable axially along the channel while being retained from being withdrawn perpendicular to the axis by the retention lips.

Preferably, the means for positioning the first support and the second support in abutting edge to edge relation may be a series of hinges. The hinges allow the first support and the second support to fold relative to each other to define a folded position in which the bottom surface of the first support and the bottom surface of the second support are in parallel spaced relation. Preferably, the first support and the second support may be secured in the folded position by at least one latch fastener to prevent unfolding during storage or transport.

Preferably, there may be an aperture located proximate the middle of the working surface.

Preferably, there may be a series of post retainers are located along the edges of the working surface and guard fences being provided with posts that are removably received in the post retainers. Preferably, there may be a roof structure is supported by the guard fences in a position overlying the working surface.

Preferably, each of the clamping fastener assemblies may comprise a clamping member having a bolt receiving passage and a bolt that extends through the bolt receiving passage in the clamping member to engage a nut in the fastener receiver.

In another aspect, there is provided a method for reusability installing an elevator work deck including the steps of positioning a first support on top of an elevator car sling, the first support having a top surface and a bottom surface, with fastener receivers positioned on the bottom surface. Subsequently, positioning a second support on top of an elevator car sling, the second support having a top surface and a bottom surface, with fastener receivers positioned on the bottom surface. Subsequently, securing the first support and the second support in abutting edge to edge relation so that the top surface of the first support and the top surface of the second support define a planar horizontal working surface when assembled in an operative position. Subsequently, securing the first support and the second support to the elevator car sling using clamping fastener assemblies which engage the fastener receivers to clamp the first support and the second support to elevator car sling structural beams.

Preferably, there may be an additional subsequent step of installing guard fences along the edges of the working surface. Preferably, there may be a further additional subsequent step of installing a roof structure over the working surface, the roof structure being supported by the guard fences.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of the elevator work deck shown in operation within an elevator shaft.

FIG. 2 is a bottom plan view of the elevator work deck.

FIG. 3 is a front elevation view of the elevator work deck.

FIG. 4 is a front elevation view of the elevator work deck in use and removably attached to elevator car sling structural beams.

FIG. 5 is a side elevation view of the elevator work deck.

FIG. 6 is a side elevation view of the elevator work deck and removably attached to elevator car sling structural beams.

FIG. 7 is a magnified side elevation view of the fastener receiver and clamping fastener assembly of the elevator work deck in use and removably attached to elevator car sling structural beams.

FIG. 8 is a magnified front elevation view of the fastener receiver and clamping fastener assembly of the elevator work deck in use and removably attached to elevator car sling structural beams.

FIG. 9 is a front elevation view of the elevator work deck including guard fences.

FIG. 10 is a front elevation view of the elevator work deck including guard fences and a roof structure.

FIG. 11 is a side elevation view of the elevator work deck including guard fences.

FIG. 12 is a side elevation view of the elevator work deck including guard fences and a roof structure.

FIG. 13 is an exploded top plan view of the elevator work deck including guard fences and a roof structure.

FIG. 14. is a top plan view of the assembled elevator work deck illustrated in FIG. 13.

FIG. 15 is a top plan view of the elevator work deck in a folded position.

FIG. 16 is a side elevation view of the elevator work deck in a folded position.

### DETAILED DESCRIPTION

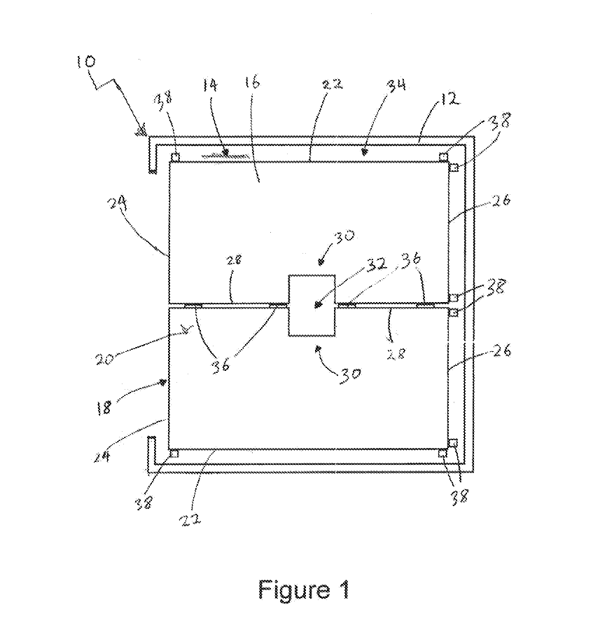

An elevator work deck generally identified by reference numeral 10, will now be described with reference to FIG. 1 through 16.

### Structure and Relationship of Parts:

Now referring to FIG. 1, elevator work deck 10 is shown in use within an elevator shaft 12. Work deck 10 includes a first support 14 having a top surface 16 and a second support 18 having a top surface 20. Both first and second supports 14 and 18 further include outer edges 22, front edges 24, back edges 26 and inner edges 28. Inner edges 28 further include notches 30 defining an aperture 32. First support 14 is substantially in abutting edge to edge relation with second support 18 (inner edge 28 of the first support 14 abutting the inner edge 28 of the second support 18) when work deck 10 is in its operative and unfolded orientation. In this operative and unfolded orientation, top surfaces 16 and 20 define a planar horizontal working surface 34 which is used to safely support elevator construction workers.

Four hinges 36 are positioned in spaced series between the two inner edges 28 to removably attach first support 14 to second support 18. The hinges 36 are disposed along inner edges 28 and proximate to working surface 34 such that outer edges 22 may only be folded upwards relative to the horizontal plane defined by planar horizontal working surface 34. Thus, positioning of hinges 36 ensures rigidity of the working surface 34 and enhances the safety of working surface 34.

Work deck 10 further includes two hollow post retainers 38 positioned in spaced series along the two outer edges 22 and four hollow post retainers 38 positioned in spaced series along the two front edges 26. As readily appreciated, front edges 24 do not include any post retainers 38. As will be described in further detail below, post retainers 38 are not necessary on front edges 24 for enhanced worker accessibility on & off of the deck 10.

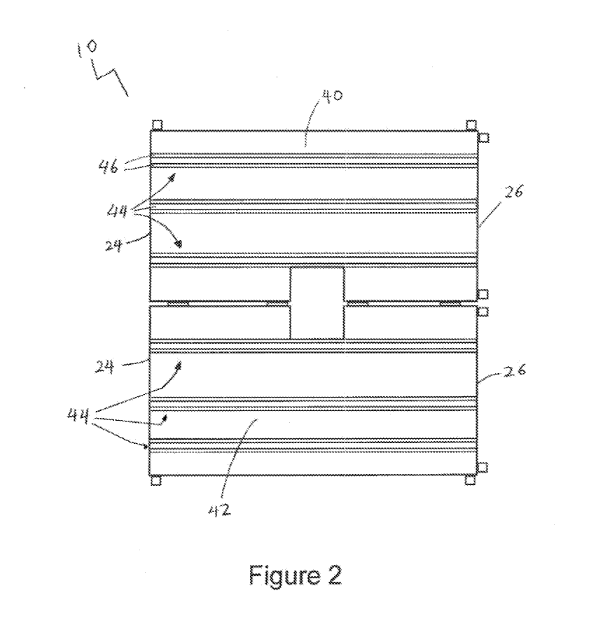

Now referring to FIG. 2, first support 14 has a bottom surface 40 and second support 18 has a bottom surface 42. Three channel members 44 are attached to bottom surface 40 and positioned in parallel relation to each other and span from front edge 24 to back edge 26. Three channel members 44 are attached to bottom surface 42 and positioned in parallel relation to each other and span from front edge 24 to back edge 26. Each channel member 44 further includes two lips 46.

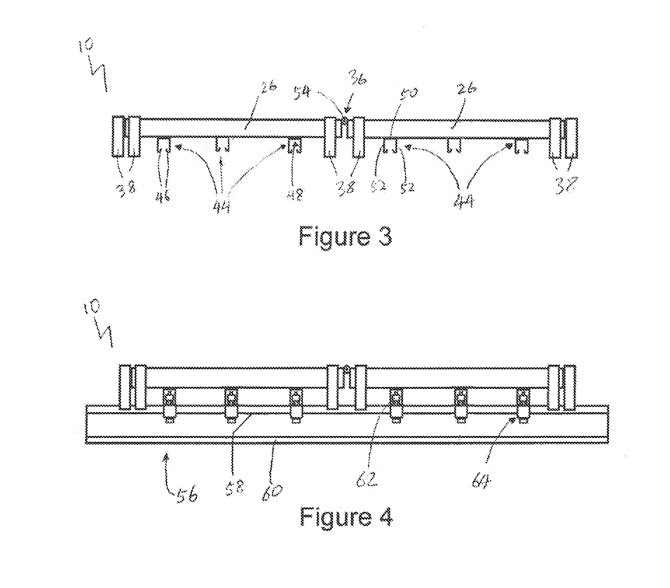

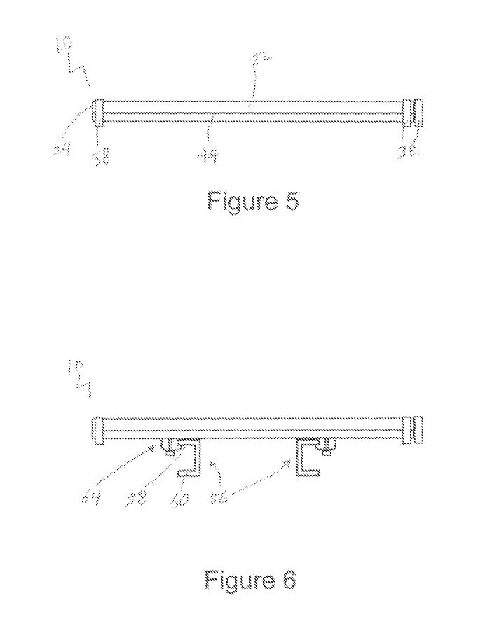

Now referring to FIGS. 3 and 5, each channel member 44 further includes an upper wall 50 and two side walls 52. Channel 48 is substantially defined by upper wall 50, the two side walls 52 and the two lips 46. Each hinge 36 further includes a removable hinge pin 54.

Now referring to FIGS. 4 and 6, the work deck 10 is shown removably attached to two C-beams 56 of an elevator permanent car sling. Each C-beam 56 includes an upper lip 58 and lower lip 60. As will be detailed in detail below, means for removably attaching two C-beams 56 to work deck 10 includes inserting twelve captured nuts 62 in to the six channels 48 and removably engaging twelve clamping fastener assemblies 64 to captured nuts 62.

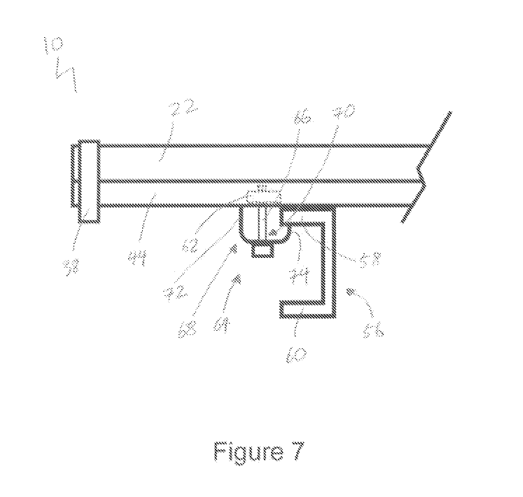

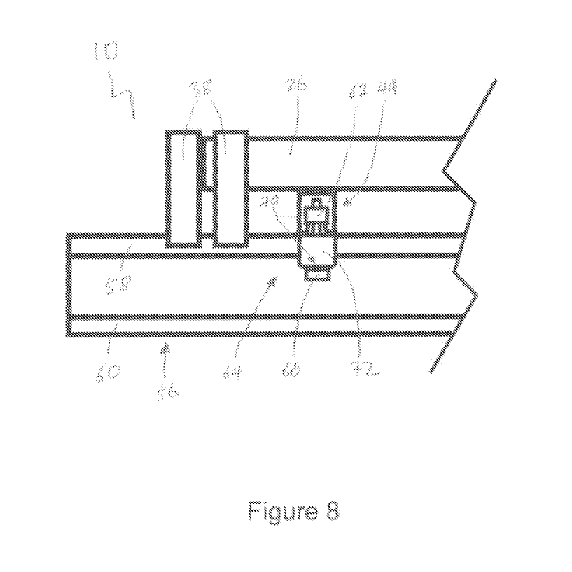

Now referring to FIGS. 7 and 8, clamping fastener assembly 64 includes a threaded bolt 66, and a clamping member 68 having an aperture 70, a side 72 and a truncated side 74. Bolt 66 is removably screwed in to captured nut 62. Side 72 extends vertically past truncated side 74 a distance substantially equal to the thickness of upper lip 58 such that when side 74 abuts against channel member 44, truncated side 74 abuts against upper lip 58. Thus, when clamping members 68 are engaged to channel members 44 and C-beams 56, the platform 10 is prevented from moving in any direction.

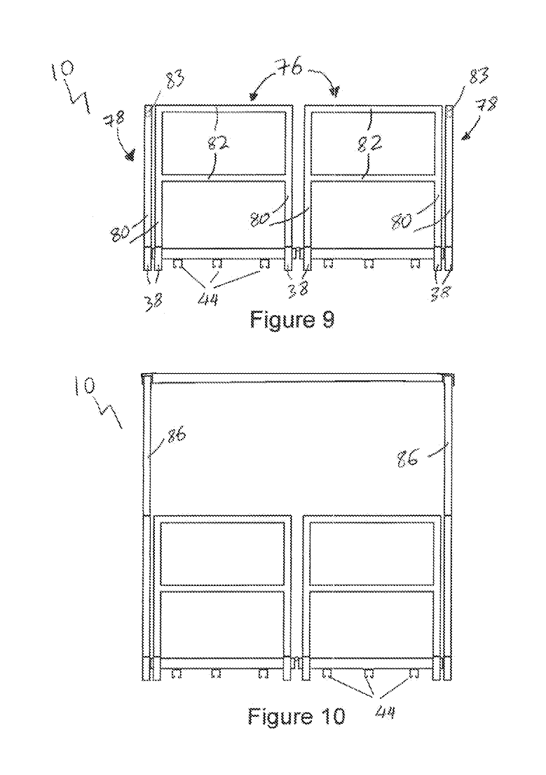

Now referring to FIGS. 9 and 11, work deck 10 preferably includes two small guard fences 76 along the two back edges 26 and two large guard fences 78 along the two outer edges 22. Each of the guard fences 76 and 78 have two fence posts 80 removably engaged to each corresponding post retainer 38. Each of guard fences 76 and 78 include railings 82. The guard fences 76 and 78 provide enhanced fall protection safety for workers. The top of each of the fence posts 80 of the large fences 78 further includes an aperture 83 for receiving additional posts as described below.

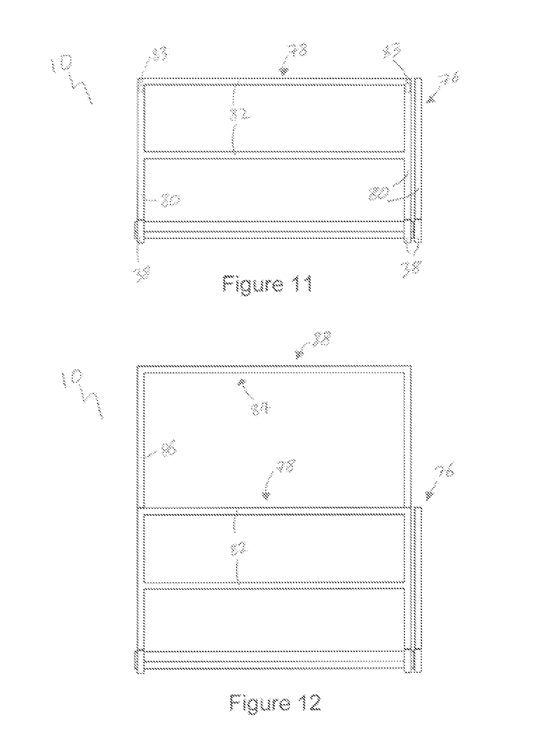

Now referring to FIGS. 10 and 12, work deck further preferably includes a roof structure 84 removably attached to large guard fences 78. Roof structure 84 includes four posts 86 and a roof 88. Posts 86 are removably engaged with corresponding apertures 83.

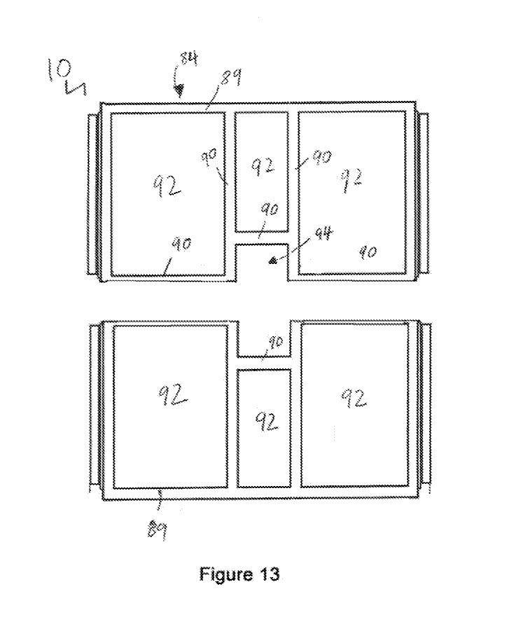

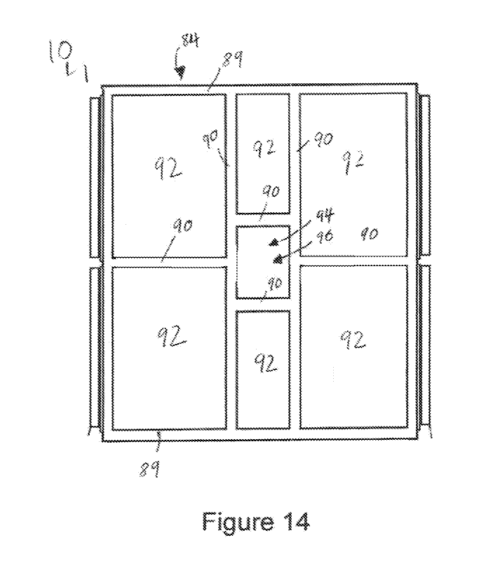

Now Referring to FIG. 13, roof 88 includes two frames 89 and structural support members 90. Referring to FIG. 14, when two frames 89 are assembled, a roof aperture 94 is disposed proximate the center of roof 88 and substantially corresponds with aperture 32 to define a cable channel 96 passing through the roof and between the first support 14 and the second support 18. Roof 88 further includes roof panels 92 formed from a resilient material such as expanded steel.

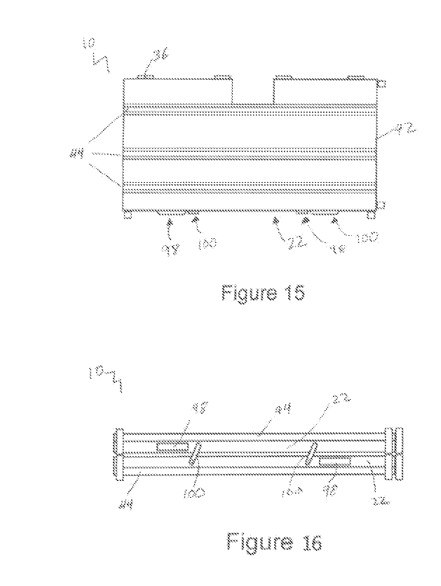

Now referring to FIGS. 15 and 16, work deck 10 is shown in a folded orientation for transport or storage. Work deck 10 is folded approximately 180 degrees from its operative and unfolded horizontal orientation along hinges 36 such that top surfaces 16 and 20 are stacked in face to face relation and bottom surfaces 40 and 42 form outside surfaces. Two handles 98 are attached to the outer edges 22 and two latches 100 are disposed between the two outer edges 22 to prevent the unfolding of work deck 10.

It should be appreciated that, due to safety concerns, resilient materials, such as steel are used to construct work deck 10 such that work deck 10 may safely withstand the weight of at least two workers.

### Operation:

Referring now to FIGS. 1 and 3, the design of work deck 10 allows simple and quick installation and removal of work deck 10 to elevator shaft 12. For worker safety the work deck 10 should cover a large area of the elevator shaft 12. Thus, but for the method described below, installation and subsequent removal of platform 10 would be difficult.

First, first support 14 is maneuvered in to shaft 12 and positioned on top of the C-beams 56 of a permanent elevator car sling. Next, second support 18 is maneuvered in to shaft 12 and positioned on top of the C-beams of a permanent elevator car sling and along side first support 14 such that hinges 36 are aligned. Hinge pins 54 are inserted in to hinges 36 to attach the first support 14 to the second support 18 such that top surfaces 16 and 20 define form planar horizontal working surface 34.

It should be appreciated that, an alternative to the above method wherein the supports 14 and 18 are maneuvered into shaft 12 independently of each other, is maneuvering supports 14 and 18 attached together in the folded orientation as described above. This alternative method is preferably used when elevator cables do not prevent the folding or unfolding of platform 10 and apertures 32 and 94 become unnecessary.

Next now referring to FIGS. 7 and 8, the clamping fastener assemblies 64 are positioned in clamping relation with channel members 44 and the upper lips 58 of C-beams 56. Next, bolts 66 are screwed in to captured nuts 62.

Now referring to FIGS. 9, 10, 13 and 14, in high-rise construction applications where the height of the elevator shaft 12 increases the severity of injuries sustained in a fall or sustained from objects falling in to shaft 12, guard fences 76 and 78, and roof structure 84 are installed. Guard fences 76 and 78 are installed by inserting each post 80 in to each corresponding post retainer 38. The roof structure 84 is installed by inserting each post 86 in to each corresponding aperture 83. The cable channel 96 allows the unobstructed passage of ropes or cables required during elevator construction.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An elevator work deck comprising:
a first support having a top surface and a bottom surface;
a second support having a top surface and a bottom surface;
means for positioning the first support and the second support in abutting edge to edge relation so that the top surface of the first support and the top surface of the second support define a planar horizontal working surface when assembled in an operative position;
fastener receivers positioned on the bottom surface of each of the first support and the second support; and
clamping fastener assemblies engaging the fastener receivers to clamp the first support and the second support to elevator car sling structural beams.

2. The elevator work deck of claim 1, wherein a channel member is secured to the bottom surface of each of the first support and the second support, the channel member having retention lips extending parallel to an axis of the channel member, the fastener receivers being movable axially along the channel while being retained from being withdrawn perpendicular to the axis by the retention lips.

3. The elevator work deck of claim 1, wherein the means for positioning the first support and the second support in abutting edge to edge relation is a series of hinges, the hinges allowing the first support and the second support to fold relative to each other to define a folded position in which the bottom surface of the first support and the bottom surface of the second support are in parallel spaced relation.

4. The elevator work deck of claim 3, wherein the first support and the second support are secured in the folded position by at least one latch fastener to prevent unfolding during storage or transport.

5. The elevator work deck of claim 1, wherein there is an aperture located proximate the middle of the working surface.

6. The elevator work deck of claim 1, wherein a series of post retainers are located along the edges of the working surface, guard fences being provided with posts that are removably received in the post retainers.

7. The elevator work deck of claim 6, wherein a roof structure is supported by the guard fences in a position overlying the working surface.

8. The elevator work deck of claim 1, wherein each of the clamping fastener assemblies comprise a clamping member having a bolt receiving passage and a bolt that extends through the bolt receiving passage in the clamping member to engage a nut in the fastener receiver.

9. An elevator work deck comprising:
a first support having a top surface and a bottom surface;
a second support having a top surface and a bottom surface;
a series of hinges positioning the first support and the second support in abutting edge to edge relation so that the top surface of the first support and the top surface of the second support define a planar horizontal working surface when assembled in an operative position, the hinges allowing the first support and the second support to fold relative to each other to define a folded position in which the bottom surface of the first support and the bottom surface of the second support are in parallel spaced relation.
a channel member is secured to the bottom surface of each of the first support and the second support, each channel member having retention lips extending parallel to an axis of the channel member,
fastener receivers positioned in each channel member, the fastener receivers being movable axially along the channel members while being retained from being withdrawn perpendicular to the axis by the retention lips; and
clamping fastener assemblies engaging the fastener receivers to clamp the first support and the second support to elevator car sling structural beams, each of the clamping fastener assemblies comprising a clamping member having a bolt receiving passage and a bolt hat extends through the bolt receiving passage to engage a nut in the fastener receiver.

10. The elevator work deck of claim 9, wherein at least one latch fastener is provided to secure the first support and the second support in the folded position.

11. The elevator work deck of claim 9, wherein there is an aperture located proximate the middle of the working surface.

12. The elevator work deck of claim 9, wherein a series of post retainers are located along the edges of the working surface, guard fences being provided with posts that are removably received in the post retainers.

13. The elevator work deck of claim 12, wherein a roof structure is supported by the guard fences in a position overlying the working surface.

14. A method for reusability installing an elevator work deck comprising the steps of:
positioning a first support on top of an elevator car sling, the first support having a top surface and a bottom surface, with fastener receivers positioned on the bottom surface;
positioning a second support on top of an elevator car sling, the second support having a top surface and a bottom surface, with fastener receivers positioned on the bottom surface;
securing the first support and the second support in abutting edge to edge relation so that the top surface of the first support and the top surface of the second support define a planar horizontal working surface when assembled in an operative position; and
securing the first support and the second support to the elevator car sling using clamping fastener assemblies which engage the fastener receivers to clamp the first support and the second support to elevator car sling structural beams.

15. The method of claim 14, further comprising the step of installing guard fences along the edges of the working surface.

16. The method of claim 15, further comprising the step of installing a roof structure over the working surface, the roof structure being supported by the guard fences.
